(19) United States
(12) Patent Application Publication
(10) Pub. No.: US 2013/0095296 A1
(43) Pub. Date: Apr. 18, 2013

(54) Photovoltaic Substrate

(71) Applicants: Sharone Zehavi, San Jose, CA (US); Raanan Y. Zehavi, San Jose, CA (US)

(72) Inventors: Sharone Zehavi, San Jose, CA (US); Raanan Y. Zehavi, San Jose, CA (US)

(73) Assignee: INTEGRATED PHOTOVOLTAIC, INC., San Jose, CA (US)

(21) Appl. No.: 13/272,073

(22) Filed: Oct. 12, 2011

(51) Int. Cl. B32B 3/10; B05D 1/36; B32B 9/00

(52) U.S. Cl. 428/172; 428/408; 428/220; 427/261

(57) ABSTRACT

A composite substrate comprising a graphitic layer and a semiconductor layer for a photovoltaic device is disclosed.

### CROSS-REFERENCE TO RELATED APPLICATIONS

This application is related in part to U.S. application Ser. Nos. 12/074,651, 12/720,153, 12/749,160, 12/789,357, 12/860,048, 12/860,088, 12/950,725, 13/010,700, 13/019,965, 13/073,884, 13/077,870, 13/214,158, 13/234,316, 13/268,041, and U.S. Pat. No. 7,789,331, all owned by the same assignee and incorporated by reference in their entirety herein. Additional technical explanation and background is cited in the referenced material.

### BACKGROUND OF THE INVENTION

1. Field of the Invention

The invention relates generally to a composite substrate optimized for a photovoltaic device.

2. Description of Related Art

U.S. Pat. No. 5,340,410 discloses a silicon nucleation layer produced on amorphous substrates with a nucleation layer being selectively etched until uniformly <111> orientated nuclei remain. U.S. Pat. No. 5,273,911 discloses a thin-film solar cell having a thin-film active layer on a graphite sheet substrate includes the steps of adhering two sheets of graphite together, forming semi-conductor thin films serving as active layers on second main surfaces of the two sheets of graphite. U.S. Pat. No. 3,961,997 discloses low-cost polycrystalline silicon cells supported on substrates are prepared by depositing successive layers of polycrystalline silicon containing appropriate dopants over supporting substrates of a member selected from the group consisting of metallurgical-grade polycrystalline silicon, graphite and steel coated with a diffusion barrier of silica, borosilicate, phosphosilicate, or mixtures thereof. U.S. Pat. No. 4,077,818, a continuation of U.S. Pat. No. 3,961,997, discloses improving the conversion efficiency of the polycrystalline silicon solar cells, the crystallite size in the silicon is substantially increased by melting and solidifying a base layer of polycrystalline silicon before depositing the layers which form the p-n junction. It is evident from the low resistivity of the initial silicon layer that considerable impurities have penetrated into it; Chu reports efficiencies of about 3%, an interesting number for 1976. The instant invention has produced cells with efficiencies greater than 9% and anticipates greater than 12%.

U.S.2010/0213643 discloses synthesis of polycrystalline silicon sheets where silica (SiO₂) and elemental carbon (C) are reacted under RF or MW excitation. These polycrystalline silicon sheets can be directly used as feedstock/substrates for low cost photovoltaic solar cell fabrication. Other techniques, such as textured polycrystalline silicon substrate formation, in situ doping, and in situ formation of p-n junctions, are described, which make use of processing equipments and scheme setups of various embodiments of the invention.

Margiotta and coworkers disclosed the formation of SiC in “Microstructural evolution during silicon carbide (SiC) formation by liquid silicon infiltration using optical microscopy”; Intl. JL. Refractory Metals and Hard Materials, 28, 2, March 2010, 191. Optical microscopy and quantitative digital image analysis were used to examine the formation of fully dense, net shape silicon carbide by liquid silicon infiltration (LSI) of porous carbon preforms. By examining the phase distribution and structural changes during the reaction, they identified six reaction stages (I-VI) that describe reaction mechanisms and their time scales. The initial stages (0-15 min) of the LSI reaction include (I) liquid silicon infiltration of the carbon preform, (II) dissolution of carbon, and (III) formation of silicon carbide at the liquid-solid interfacial regions. These initial stages occur simultaneously and very rapidly, and culminate in (IV) the completion of a continuous silicon carbide layer of about 10 μm at every liquid-solid interface. Further reaction can only be achieved by (V) carbon diffusion through this layer. The reaction is essentially complete after 20 min. Longer reaction times should be avoided because over-reacting causes (VI) long, thin silicon-filled cracks to develop within the continuous silicon carbide matrix.

U.S.2010/0132773 discloses lithographically patterned graphite stacks as the basic building elements of an efficient and economical photovoltaic cell. The basic design of the graphite-based photovoltaic cells includes a plurality of spatially separated graphite stacks, each comprising a plurality of vertically stacked, semiconducting graphene sheets (carbon nanoribbons) bridging electrically conductive contacts. All references cited herein are incorporated in their entirety by reference.

### BRIEF SUMMARY OF THE INVENTION

A low cost, “universal” substrate would be very beneficial for the solar cell industry. The instant invention discloses a composite substrate with multiple layers suitable for a photovoltaic device; photovoltaic devices fabricated on a composite substrate may comprise Group IV, III-V or II-VI semiconductors. In some embodiments a composite substrate comprises a plurality of layers formed of low cost materials, optionally, silicon in combination with various forms of carbon, such as graphite, silicon carbide and silicon/carbon composites. Optional layers include one or more barrier layers, a cap layer, a conductive layer, an anti-reflection layer, a reflective layer and a distributed Bragg reflector layer. A goal of the instant invention is to disclose a composite substrate with various combinations of layers such that photovoltaic devices designed for different applications can be constructed thereon in a cost effective manner.

In some embodiments the invention discloses deposition of a layer of silicon onto a graphite layer. The graphite layer may be in the form of graphitic “cloth” or “paper” or powder. The deposited silicon or other semiconductor may be deposited from a plasma spray, CVD, PECVD or other deposition process known to one knowledgeable in the art; optionally, silicon may be molten and poured onto a graphitic layer. In some embodiments a composite substrate comprising at least a silicon, or semiconductor, and a carbon-based layer ranges from about 25 microns to about 1,000 microns in thickness with substantially only silicon being in the upper most layer.

Should the upper most silicon layer contain contaminants that may diffuse into active semiconductor layers, or when a silicon layer, suitably conductive and operable in a composite substrate, create a junction with an adjacent, active semiconductor layer and thereby reduce the efficiency of an intended device by promoting recombination, the conductive silicon layer may be coated with a dielectric barrier layer, optionally non-conducting. In some embodiments, a non-contaminating and non-recombining interface is created with a barrier layer comprising an array of vias, enabling effective collection of a photocurrent.

### BRIEF DESCRIPTION OF THE SEVERAL VIEWS OF THE DRAWINGS

FIG. 1 Schematic structure of exemplary composite substrate with various layers.

### DETAILED DESCRIPTION OF THE INVENTION

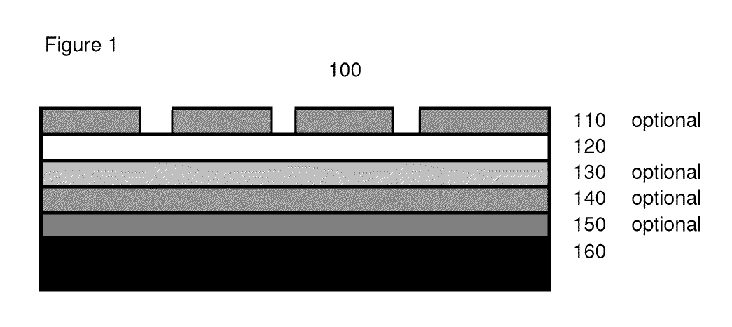

FIG. 1 shows an exemplary composite substrate 100 with various optional layers; two layers, 120 and 160, are not optional; layer 120 is a semiconductor, optionally, from Group IV, III-V or II-VI and provides a transition or interface to a photovoltaic device, not shown. Layer 110 is an optional barrier layer comprising optional vias, as shown; layer 130 is an optional reflective layer; 140 is an optional silicon/carbon layer, optionally, silicon carbide; layer 150 is an optional barrier layer between graphitic substrate 160 and the upper layers. In some embodiments only layers 120 and 160 are present; in some embodiments some combination of layers 110, 130, 140 and 150 are also present. In some embodiments the order of the layers is different than what appears in FIG. 1; for instance layer 130 may separate layers 160 and 150.

Some embodiments comprise deposition by high-purity plasma spray of one or more layers of composite substrate 100. High temperature plasma spray deposition and associated processes are typically done as described in one or more of the references cited above, including Ser. Nos. 12/074,651, 12/720,153, 12/749,160, 12/789,357, 12/860,048, 12/860,088, 12/950,725, 13/010,700, 13/019,965, 13/073,884, 13/077,870, 13/214,158, 13/234,316, 13/268,041 and U.S. Pat. No. 7,789,331

In some embodiments semiconductor layer 120 may undergo Zone Melt Recrystallization, ZMR, as disclosed in U.S. application Ser. Nos. 12/789,357 and 13/234,316. Depending on the speed of heating and cooling a surface, one can control the quality of the recrystallization and the grain size of a recrystallized silicon surface.

In some embodiments semiconductor layer 120 may comprise a Group IV, III-V or II-VI semiconductor; optional steps comprising one or more of the following may be added: depositing barrier layer 110, optionally reflective, on semiconductor layer 120; and forming vias in the barrier layer such that area fraction of vias in the first barrier is between about 0.01 and 0.20, wherein the steps are done just prior to depositing a second semiconductor layer onto the layer 110.

In some embodiments a composite substrate comprises a first layer 160 composed substantially of a carbon based material; a second layer 120 composed substantially of silicon; and a third layer 140, substantially continuous, of SiC separating the first layer from the second layer; optionally, the third layer 140 is formed by a reaction between the second layer and the first layer during a deposition process; optionally, the deposition process is one or more processes chosen from a group consisting of physical vapor deposition, chemical vapor deposition, atmospheric pressure, ±5 psig, chemical vapor deposition, plasma-enhanced chemical vapor deposition, molten source application, plasma spraying and high temperature sintering done following the deposition of a silicon layer such that a substantially continuous SiC layer is formed as the third layer. Optionally, first layer 160 is chosen from a group consisting of graphite, graphite foil, glassy graphite, impregnated graphite, pyrolytic carbon, pyrolytic carbon coated graphite, flexible foil coated with graphite, graphite powder, carbon paper, carbon cloth, carbon, ceramic coated with graphite, carbon nanotube coated substrates, carbide coated substrates, graphene coated substrates, silicon-carbon composite, silicon carbide, and mixtures thereof; optionally, the substrate is flexible; optionally, the substrate has a thickness of less than 80 microns and a surface resistivity of less than about 100 Ω/sq.; optionally, the substrate has a thickness between about 100 microns and 600 microns and a surface resistivity of less than 50 Ω/sq.; optionally, the second layer has a lateral grain size greater than about 50 microns after a recrystallization step as described in U.S. Ser. No. 13/234,316; optionally, the second layer has a lateral grain size greater than about 1 mm after recrystallization; optionally, the second layer has a lateral grain size greater than about 10 mm after recrystallization; optionally, the substrate further comprises a reflective layer separating the third layer from the second layer substrate; optionally, the second layer and third layers are formed by from a molten source of silicon dispensed directly onto the carbon based layer; optionally, the second layer is planarized; optionally, by CMP or oxidation, such that the mean surface roughness of the second layer after planarization is less than ±20 microns; optionally, a barrier layer is formed between the first layer and the second layer; optionally, formed between the first layer and the third layer; optionally, the third layer is a reflective layer. In some embodiments the composite substrate comprises a second layer which has been recrystallized such that the second layer is held at temperature above 1200° C. for longer than 5 seconds during the recrystallization process; optionally, the second layer has been recrystallized such that the second layer has a lateral grain size greater than about 3 mm; optionally, the second layer has been recrystallized such that the second layer has a lateral grain size greater than about 10 mm.

As used herein lateral grain size is taken to be the size of the grains in the plane of the substrate surface, perpendicular to a grain face. A customer may select a desired grain size ranging from about 10 microns to more than 10 mm depending upon desired device characteristics and cost constraints. As used herein the statement “the second layer has a lateral grain size greater than about XX mm after a recrystallization step . . . ” means that more than 90% of the crystal grains in the second layer have a lateral grain size greater than about the indicated value. A barrier layer as used herein is a layer of a composition such that impurities on one side of the layer are impeded from diffusing through the barrier layer in a deleterious amount.

In some embodiments a method for forming a substantially continuous layer of silicon carbide between a carbon based substrate and a silicon layer comprises the steps; selecting a carbon based substrate; depositing a first layer consisting of carbon and silicon of a first carbon/silicon; optionally the deposition takes place in a substantially, ±5 psig, atmospheric pressure chemical vapor deposition reactor; depositing a second layer consisting of carbon and silicon of a second carbon/silicon ratio optionally the carbon/silicon ratio is zero; in an atmospheric pressure chemical vapor deposition reactor; and planarizing by CMP or oxidizing the second layer such that the mean surface roughness after oxidation is less than ±20 microns.

In some embodiments a method for forming a substantially continuous layer of silicon carbide between a carbon based substrate and a silicon layer comprises the steps selecting a carbon based substrate; depositing a first layer consisting of carbon and silicon of a first carbon/silicon ratio; optionally, the C/Si ratio may be zero; depositing the silicon layer consisting substantially of silicon; and recrystallizing the second layer such that the mean lateral dimension of the recrystallized grains is greater than about 5 mm, optionally greater than about 10 mm; optionally, the recrystallisation step is as described in U.S. Ser. No. 13/234,316; optionally, the second layer is recrystallized such that the second layer is held at temperature above 1200° C. for longer than 5 seconds.

In some embodiments a method of recrystallizing a layer of material comprises the steps: selecting a composite substrate with the layer deposited onto the substrate; advancing the substrate through first zone, S, such that a temperature, T_{S}, is established within at least a portion of the deposited layer wherein Ts is less than the melting point, T_{MP}, of the layer; advancing the substrate through second zone, I, such that a temperature, T_{I}, is established within at least a portion of the deposited layer wherein T_{I} is greater than T_{S}; advancing the substrate through third zone, M, such that a temperature, T_{M}, is established within at least a portion of the deposited layer wherein T_{M} is greater than T_{MP}; and advancing the substrate through fourth zone, R, such that a temperature, T_{R}, is established within at least a portion of the deposited layer wherein T_{R} is below T_{MP}, of the deposited layer and above a predetermined temperature, X*T_{MP}, for at least Y seconds wherein the substrate and layer are advanced through the first through fourth zones sequentially at a rate of about Q mm/sec. such that the temperature criteria of each zone is established within at least a portion of the deposited layer while that portion is physically within the respective zone; optionally, X is between about 0.99 and about 0.60; optionally, Y is between about 0.1 and about 30 seconds; optionally, the second zone comprises one or more means for heating chosen from a group consisting of a spot of radiation rapidly scanned over the substrate, a linear array of radiation projected onto the substrate, laser, flash lamp, resistance heaters, rf coils, microwave radiation, and infra-red heaters; optionally, the first and third zones comprise one or more means for temperature modulation chosen from a group consisting of a spot of radiation rapidly scanned over the substrate, a linear array of radiation projected onto the substrate, laser, flash lamp, resistance heaters, rf coils, microwave radiation, infra-red heaters and means for cooling comprising refrigeration coils, thermoelectric means, fans, and cooling coils; optionally, the deposited layer material is substantially one or more elements chosen from a group consisting of Group II, III, IV, V and VI elements; optionally, the second and third zone length combined are more than 5 mm long in the direction of substrate travel; optionally, the substrate advancing rate, Q, is at least 0.5 mm per second.

In some embodiments a solid state device comprises a composite substrate comprising a a second layer comprising material recrystallized by the method of U.S. Ser. No. 13/234,316; optionally, the second layer comprises material recrystallized such that more than 90% of the recrystallized layer has crystal grains of a size greater than 3 mm in any lateral dimension parallel to the substrate surface; optionally, the second layer comprises material recrystallized such that more than 90% of the recrystallized semiconductor layer has crystal grains of a size greater than 50% of the smallest lateral dimension parallel to the substrate surface; optionally, the recombination velocity is between about 50 cm/s and about 500 cm/sec; optionally, a solid state device is a solar cell wherein the recrystallized layer comprises a crystal grain at least 90% of the size of the irradiated area of the solar cell or at least 90% of the size of an individual cell in a large area solar module; optionally, the composite substrate is chosen from a group consisting of silicon, silicon composite with graphite, glass, ceramic, carbon, and a material coated with SiO₂ or SiC; optionally, a solid state device further comprises a barrier layer within the composite substrate and the first layer. In some embodiments a solar cell with a composite substrate and recrystallized layer has a conversion efficiency greater than 10%; optionally, greater than 12%.

The foregoing described embodiments of the invention are provided as illustrations and descriptions. They are not intended to limit the invention to a precise form as described. In particular, it is contemplated that functional implementation of invention described herein may be implemented equivalently in various combinations or other functional components or building blocks. Other variations and embodiments are possible in light of above teachings to one knowledgeable in the art of semiconductors, thin film deposition techniques, and materials; it is thus intended that the scope of invention not be limited by this Detailed Description, but rather by Claims following. All patents, patent applications, and other documents referenced herein are incorporated by reference herein in their entirety for all purposes.

In the preceding description, numerous specific details are set forth, such as particular structures, components, materials, dimensions, processing steps and techniques, in order to provide a thorough understanding of the present invention. However, it will be appreciated by one of ordinary skill in the art that the invention may be practiced without these specific details. In other instances, well-known structures or processing steps have not been described in detail in order to avoid obscuring the invention.

It will be understood that when an element as a layer, region or substrate is referred to as being “on” or “over” or “adjacent” another element, it can be directly on the other element or intervening elements may also be present. In contrast, when an element is referred to as being “directly on” or “directly over” or “in contact with” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

We claim:

1. A composite substrate for a photovoltaic device comprising:
first layer composed substantially of carbon based material;
second layer composed substantially of silicon; and
third layer, substantially continuous, of SiC separating the first layer from the second layer.

2. The composite substrate of claim 1 wherein the third layer is formed by a reaction between the second layer and the first layer during a deposition process.

3. The composite substrate of claim 2 wherein the deposition process is one or more processes chosen from a group consisting of physical vapor deposition, chemical vapor deposition, atmospheric pressure chemical vapor deposition, plasma-enhanced chemical vapor deposition, molten source application, plasma spraying and high temperature sintering.

4. The composite substrate of claim 1 wherein the first layer is chosen from a group consisting of graphite, graphite foil, glassy graphite, impregnated graphite, pyrolytic carbon, pyrolytic carbon coated graphite, flexible foil coated with graphite, graphite powder, carbon paper, carbon cloth, carbon, ceramic coated with graphite, carbon nanotube coated substrates, carbide coated substrates, graphene coated substrates, silicon-carbon composite, silicon carbide, and mixtures thereof.

5. The composite substrate of claim 4 wherein the first layer is flexible.

6. The composite substrate of claim 1 wherein the composite substrate has a thickness of less than 100 microns and a surface resistivity of less than about 100 Ω/sq.

7. The composite substrate of claim 1 wherein the composite substrate has a thickness between about 100 microns and 600 microns and a surface resistivity of less than 50 Ω/sq.

8. The composite substrate of claim 1 wherein the second layer has been recrystallized such that the second layer is held at temperature above 1200° C. for longer than 5 seconds during the recrystallisation process.

9. The composite substrate of claim 1 wherein the second layer has been recrystallized such that the second layer has a lateral grain size greater than about 3 mm.

10. The composite substrate of claim 1 wherein the second layer has been recrystallized such that the second layer has a lateral grain size greater than about 10 mm.

11. The composite substrate of claim 1 wherein the substrate further comprises a reflective layer separating the first layer from the second layer.

12. The composite substrate of claim 1 wherein the second layer and third layers are formed from a molten source of silicon dispensed directly onto the carbon based layer.

13. The composite substrate of claim 1 further comprising a barrier layer between the first layer and the second layer.

14. A method for forming a substantially continuous layer of silicon carbide between a carbon based substrate and a silicon layer comprising the steps;
selecting a carbon based substrate;
depositing a first layer consisting of carbon and silicon of a first carbon/silicon ratio in an atmospheric pressure chemical vapor deposition reactor;
depositing a second layer consisting of carbon and silicon of a second carbon/silicon ratio in an atmospheric pressure chemical vapor deposition reactor; and
oxidizing the second layer such that the mean surface roughness after oxidation is less than ±20 microns.

15. A method for forming a substantially continuous layer of silicon carbide between a carbon based substrate and a silicon layer comprising the steps;
selecting a carbon based substrate;
depositing a first layer consisting of carbon and silicon of a first carbon/silicon ratio;
depositing the silicon layer consisting substantially of silicon; and
recrystallizing the second layer such that the mean lateral dimension of the recrystallized grains is greater than about 5 mm.
